(19) United States
(12) Patent Application Publication
(10) Pub. No.: US 2004/0084443 A1
(43) Pub. Date: May 6, 2004

(54) Method and apparatus for induction heating of a wound core

(76) Inventors: Mark A. Ulrich, New London, WI (US); Gregory D. Popp, Appleton, WI (US)

Correspondence Address: Patrick S. Yoder, Fletcher, Yoder & Van Someren, P.O. Box 692289, Houston, TX, 77269-2289, US

(21) Appl. No.: 10/286,535

(22) Filed: Nov. 1, 2002

(51) Int. Cl. H05B 6/36

(52) U.S. Cl. 219/672

(57) ABSTRACT

A method and apparatus for inductively heating a work piece. An induction heating system is used to produce a plurality of magnetic fields, each magnetic field extending through a portion of the work piece to inductively heat the work piece. At least one of the plurality of magnetic fields is oriented in a direction opposite to at least one other of the plurality of magnetic fields. The induction heating system may comprise an induction heating support structure adapted to receive the core. The induction heating system may also comprise an induction heating power source, a power source controller, an induction heating cable, and/or a fluid cooling unit.

### FIELD OF THE INVENTION

The present invention relates generally to induction heating, and particularly to a method and apparatus for inductively heating a metal object having conductive windings disposed thereon.

### BACKGROUND OF THE INVENTION

Many electrical devices utilize wound metal cores. For example, electric motors and generators typically have a rotor and a stator. These rotors and stators typically are comprised of stacks of metal laminations that are secured together to form the core. Conductive wires are then wound around the laminations to form the rotor or stator. These windings typically are coated with a layer of varnish. The varnish acts as a protective barrier and as an electrical insulator between the windings. The varnish may be air-dried. However, air-drying may take a considerable period of time to cure the varnish. In addition, some varnishes may require heat to cure. Consequently, wound cores typically are baked in an oven for four to six hours to cure the varnish.

Manufacturers are constantly seeking methods to improve the quality of their products and to decrease the time required to produce their products. Therefore, there is a need for an improved technique for curing a varnish disposed on a wound rotor. In addition, there is a need for a technique to enable a varnish disposed on a wound core to be cured in less time than the time required to bake the wound core and varnish in an oven.

### SUMMARY OF THE INVENTION

The present technique provides a novel technique for inductively heating a rotor designed to respond to such needs. According to one aspect of the present technique, an induction heating system for heating a wound core is provided. The induction heating system is used to produce magnetic fields to induce current flow in the rotor. The induction heating system comprises a power source and a plurality of induction heating coils. The plurality of induction heating coils produces magnetic fields oriented in opposite directions. A first coil may be disposed around the rotor in a first direction and a second coil may be disposed around the rotor in a second direction opposite to the first direction. A first and a second coil may be wound around the rotor in the same direction, but electrically coupled to the power source to produce electrical currents flowing in opposite directions around the rotor.

### BRIEF DESCRIPTION OF THE DRAWINGS

The invention will hereafter be described with reference to the accompanying drawings, wherein like reference numerals denote like elements, and:

FIG. 1 is an induction heating system adapted to cure a coating disposed on a wound core, according to an exemplary embodiment of the present technique;

FIG. 2 is a diagram of the process of inducing heat in a rotor using an induction heating system, according to an exemplary embodiment of the present technique;

FIG. 3 is an electrical schematic diagram of an induction heating system, according to an exemplary embodiment of the present technique;

FIG. 4 is a schematic diagram of a system for inductively heating a rotor, according to an exemplary embodiment of the present technique;

FIG. 5 is an elevational drawing illustrating the front and the rear of an induction heating system, according to an exemplary embodiment of the present technique;

FIG. 6 is a front elevational view of a temperature controller, according to an exemplary embodiment of the present technique;

FIG. 7 is an exemplary temperature profile for curing a coating of a wound core and representative programming instructions to produce the exemplary temperature profile in the wound core, according to an exemplary embodiment of the present technique;

FIG. 8 is an exemplary embodiment using a single induction heating cable wound in two directions around the wound core, according to an alternative embodiment of the present technique;

FIG. 9 is an exemplary embodiment using two induction heating cables wound in the same direction around the wound core, but electrically coupled to the induction heating power source to produce magnetic fields oriented in opposite directions, according to an alternative embodiment of the present technique;

FIG. 10 is an elevational view of a clam-shell device adapted to be disposed over a wound core to inductively heat the core, according to an alternative embodiment of the present invention; and

FIG. 11 is a top view of the clam-shell device of FIG. 10.

### DETAILED DESCRIPTION OF THE PREFERRED EMBODIMENTS

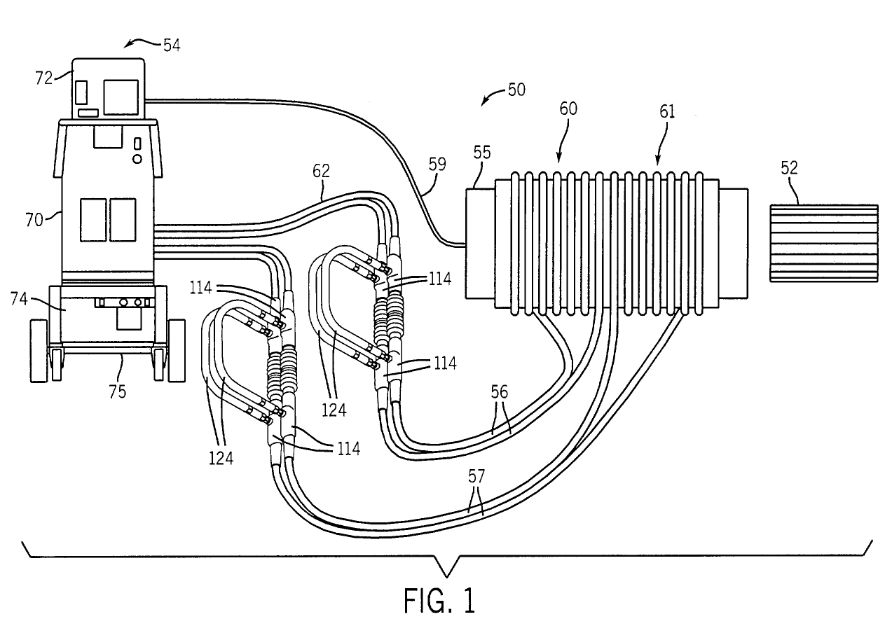

Referring generally to FIGS. 1-6, an induction heating system 50 for inductively heating a wound core 52 to cure a coating of varnish disposed on the wound core 52 is illustrated. In the illustrated embodiment, the wound core 52 is a wound rotor. However, the system 50 may be utilized to inductively heat other wound cores, such as a stator

Induction heating involves applying an AC electric signal to a conductor adapted to produce a magnetic field, such as a loop or coil. The AC electrical signal flowing through the coil produces a varying magnetic flux. A metallic object to be heated may be placed within or proximate to the coil so that the varying magnetic field passes through the object. The varying magnetic field produces eddy currents in the metallic object, heating the object. However, it has been discovered that a parasitic transformer effect is produced by the induction coil and the laminations and windings of the wound core. Consequently, the induction heating coil acts as the primary of the transformer, the laminations act as the core of the transformer, and the windings of the rotor act as the secondary of the transformer. Typically, the wound core has many more windings than does the induction heating coil. Consequently, the parasitic transformer acts as a step-up transformer, markedly increasing the voltage developed across the windings of the wound core from the voltage developed across the induction heating coil. Unfortunately, the stepped-up voltage developed across the windings produces arcing between the windings. The arcing between the windings effectively destroys the wound core.

In the illustrated embodiment, the induction heating system 50 comprises an induction power system 54, a frame 55 adapted to receive the wound core 52, a first induction heating cable 56, a second induction heating cable 57, and an insulation blanket 58 disposed around the frame 55, and at least one temperature feedback device 59. However, rigid coils may be used, rather than induction heating cables. In addition, the induction heating cables 56, 57 may be air-cooled, rather than fluid-cooled. Furthermore, the frame 55 may be adapted to facilitate air circulation. Indeed, the induction heating cables 56, 57 may be disposed directly over the frame 55, without the use of the insulation blanket 58. The induction heating cables 56, 57 also may be affixed to the frame 55. The frame 55 may be comprised of wood, glass, or other non-conductive material.

The power system 54 produces a flow of AC current through the induction heating cables 56, 57. Additionally, in this embodiment, the power system 54 provides a flow of cooling fluid through the induction heating cables 56, 57. In FIG. 1, the first induction heating cable 56 has been wrapped around the wound core 52 several times to form a first coil 60 and the second induction heating cable 57 has been wrapped around the wound core 52 several times to form a second coil 61. In the illustrated embodiment, the first and second coils 60, 61 are wound in opposite directions around the frame 55.

The AC electric current is typically produced at a high frequency, such as a radio frequency. At high frequencies, the current carried by a conductor is not uniformly distributed over the cross-sectional area of the conductor, as is the case with DC current. This phenomenon, referred to as the “skin effect”, is a result of magnetic flux lines that circle part, but not all, of the conductor. At radio frequencies, approximately 90 percent of the current is carried within two skin depths of the outer surface of a conductor. For example, the skin depth of copper is about 0.0116 inches at 50 KHz, and decreases with increasing frequency. The reduction in the effective area of conduction caused by the skin effect increases the effective electrical resistance of the conductor.

In the illustrated embodiment, the induction heating cables 56, 57 utilizes a litz wire (not shown) to produce the magnetic fields. The litz wire is used to minimize the effective electrical resistance of the induction heating cables 56, 57 at high frequencies. A litz wire utilizes a large number of strands of fine wire that are insulated from each other except at the ends where the various wires are connected in parallel. The individual strands are woven in such a way that each strand occupies all possible radial positions to the same extent. In the illustrated embodiment, the litz wire is housed within a hose. Cooling fluid flows through the hose around the litz wire. In the illustrated embodiment, extension cables 62 are used to extend the effective distance of the induction heating cables 56, 57 from the power system 54. In this embodiment, the extension cables 62 couple the induction heating cables 56, 57 to the induction power system 54 electrically and fluidicly.

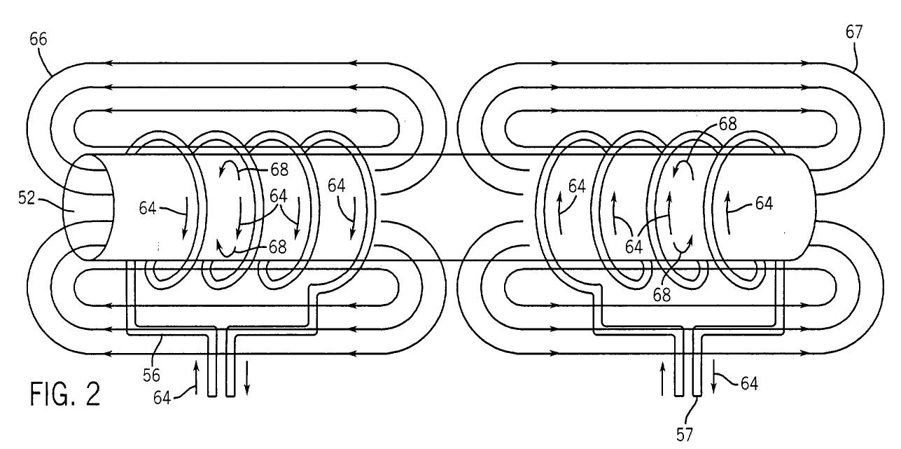

As best illustrated in FIG. 2, the AC current 64 flowing through the first coil 60 produces a first magnetic field 66 and the AC current flowing through the second coil 61 produces a second magnetic field 67. The magnetic fields 66, 67 in turn, induce eddy currents 68 in the core of the wound core 52. The induced currents 68, in turn, produce heat in the wound core 52. In the illustrated embodiment, the induction heating cables 56, 57 are wound in opposite directions around the wound core 52 and electrically coupled to the induction heating power system 54 so that the electrical currents flowing through the coils flow in opposite directions around the wound core. Thus, the magnetic fields 66, 67 are oriented in opposite directions. The magnetic fields 66, 67 will oppose each other and tend to cancel each other where the coils 60, 61 are adjacent. Although this reduces the eddy currents induced in the region where the coils are proximate to each other, it has the benefit of reducing the increase in voltage in the windings of the wound core 52 caused by the transformer effect. In addition, eddy currents 68 are still produced in the wound core 52 by the central regions of the coils. Thus, heat to cure the varnish disposed on the wound core 52 is still produced in the wound core 52 by the induction heating system 50. Preferably, three or more coils are wrapped around the wound core 52 to minimize the transformer effect.

Referring again to FIG. 1, the illustrated induction heating system 50 enables the system to be transported to a worksite or operated within a shop. The power system 54 comprises a power source 70, a temperature controller 72, and a cooling unit 74 mounted on a wheeled cart 75. The power source 70 produces the AC current that flows through the induction heating cables 56, 57. The temperature controller 72 is programmable and is operable to control the operation of the power source 70. In the illustrated embodiment, the temperature controller 72 controls the operation of the power source 70 in response to programming instructions and wound core 52 temperature data received from the temperature feedback device 59. However, the system may be operated without a temperature controller 72 or a temperature feedback device 59. For example, the optimal heating time to cure the varnish on a wound core for a given output power of the the induction heating cables 56, 57. The temperature controller 72 is programmable and is operable to control the operation of the power source 70. In the illustrated embodiment, the temperature controller 72 controls the operation of the power source 70 in response to programming instructions and wound core 52 temperature data received from the temperature feedback device 59. However, the system may be operated without a temperature controller 72 or a temperature feedback device 59. For example, the optimal heating time to cure the varnish on a wound core for a given output power of the induction heating power source 70 may be established experimentally. Thus, the wound core may be cured by heating the wound rotor at a given output power of the induction heating power source for a specified time. The illustrated embodiment also comprises a cooling unit 74 operable to provide a flow of cooling fluid to remove heat from the induction heating cables 56, 57. However, as discussed above, the cables may be air-cooled, rather than fluid-cooled.

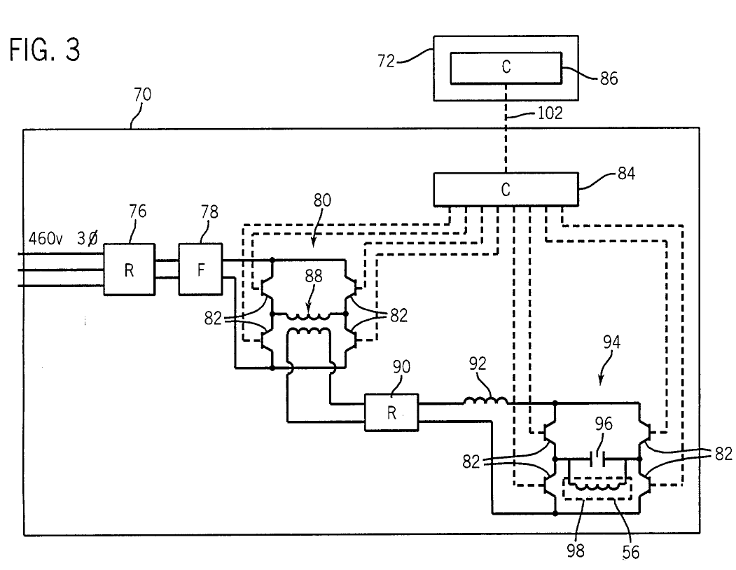

Referring generally to FIG. 3, an electrical schematic of a portion of the system 50 is illustrated. In the illustrated embodiment, 460 Volt, 3-phase AC input power is coupled to the power source 70. A rectifier 76 is used to convert the AC power into DC power. A filter 78 is used to condition the rectified DC power signals. A first inverter circuit 80 is used to invert the DC power into desired AC output power. In the illustrated embodiment, the first inverter circuit 80 comprises a plurality of electronic switches 82, such as IGBT's. Additionally, in the illustrated embodiment, a temperature controller board 84 housed within the power source 70 controls the electronic switches 82. Control circuitry 86 within the temperature controller 72 in turn, controls the controller board 84.

A step-down transformer 88 is used to couple the AC output from the first inverter circuit 80 to a second rectifier circuit 90, where the AC is converted again to DC. In the illustrated embodiment, the DC output from the second rectifier 90 is, approximately, 600 Volts and 50 Amps. An inductor 92 is used to smooth the rectified tank circuit establishes the frequency of the AC current flowing through the induction heating cable 56. The inductance of the induction heating cable 56 is influenced by the number of turns of the heating cable 56 around the wound core 52. The current flowing through the induction heating cable 56 produces a magnetic field that induces current flow, and thus heat, in the wound core 52.

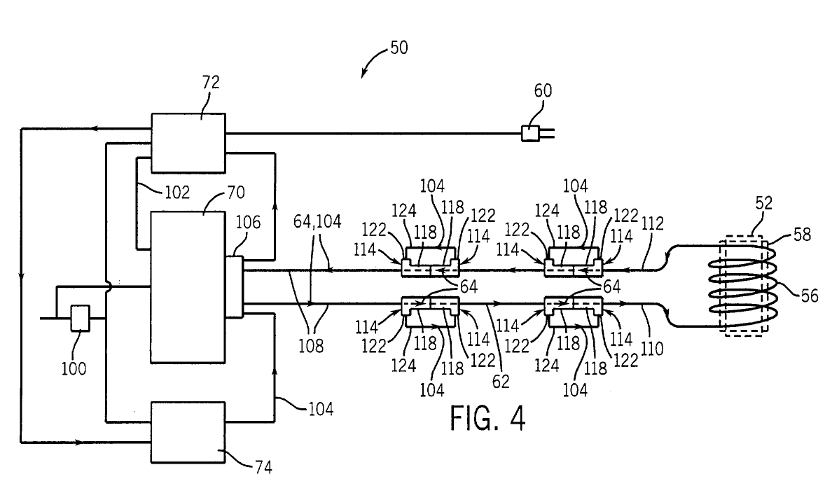

Referring generally to FIG. 4, an electrical and fluid schematic of the induction heating system 50 is illustrated. Once again, only the first induction heating cable 56 is illustrated for clarity. In the illustrated embodiment, 460 Volt, 3-phase AC input power is supplied to the power source 70 and to a step-down transformer 100. In the illustrated embodiment, the step-down transformer 100 produces a 115 Volt output applied to the fluid cooling unit 74 and to the temperature controller 72. The step-down transformer 100 may be housed separately or within one of the other components of the system 50, such as the fluid cooling unit 74 or wheeled-cart 75. A control cable 102 is used to electrically couple the temperature controller 72 72 and the power source 70.

In the illustrated embodiment, cooling fluid 104 from the cooling unit 74 flows to an output block 106. The cooling fluid 104 may be water, anti-freeze, etc. Additionally, the cooling fluid 104 may be provided with an anti-fungal or anti-bacterial solution. The cooling fluid 104 flows from the cooling unit 74 to the output block 106. Electrical current 64 from the power source 70 also is coupled to the output block 106. In the illustrated embodiment, an output cable 108 is connected to the output block 106. The output cable 108 couples cooling fluid and electrical current to an extension cable 62. The extension cable 62, in turn, couples cooling fluid 104 and electrical current 64 to the induction heating cable 56. The second induction heating cable 57 may be connected to a second output cable (not shown). In the illustrated embodiment, cooling fluid 104 flows from an output block 106 to the induction heating cable 56 along a supply path 110 through the output cable 108 and an extension cable 62. The cooling fluid 104 returns to the output block 106 from the induction heating cable 56 along a return path 112 through the extension cable 62 and the output cable 108. AC electric current 64 also flows along the supply and return paths. The AC electric current 64 produces the first magnetic field 66 that induces current 68, and thus heat, in the wound core 52. Heat, produced either from the wound core 52 or by the AC electrical current flowing through the conductors in the first induction heating cable 56 is carried away by the cooling fluid 104. Additionally, the insulation blanket 58 forms a barrier to reduce the transfer of heat from the wound core 52 to the heating cable 56.

Referring generally to FIGS. 1 and 4, each of the induction heating cables 56,57 and extension cables 62 has a connector assembly 114. In the illustrated embodiment, each connector assembly separately couples electricity and cooling fluid. As illustrated in FIG. 4, each connector assembly 114 comprises an electrical connector 118 and a hydraulic fitting 122. The connector assemblies 114 are fluidicly coupled by routing a jumper 124 from the hydraulic fitting 122 of one connector assembly 114 to the hydraulic fitting 118 of the other connector assembly 114. Electrical current 64 flows through the electrical connectors and fluid 104 flows through the hydraulic fittings 122 and jumper 124. In the illustrated embodiment, cooling fluid 104 from the first induction heating cable 56 is then coupled to the temperature controller 72. Cooling fluid flows from the temperature controller 72 back to the cooling unit 74. The cooling unit 74 removes heat from the cooling fluid 104 flowing through the induction heating cables 56, 57. The cooled cooling fluid 104 is then supplied again to the heating cable 56.

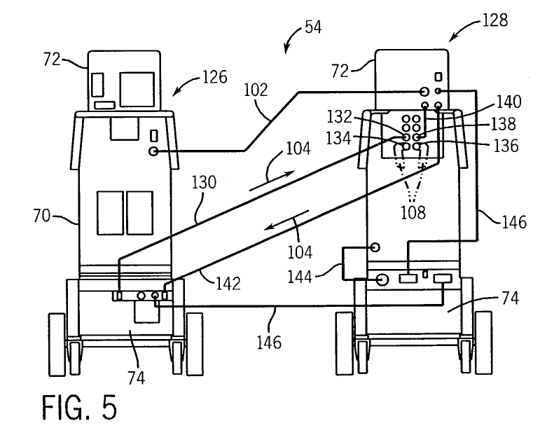

Referring generally to FIG. 5, front and rear views of a single power system 54 are illustrated. In the illustrated embodiment, the front side 126 of the power system 54 is shown on the left and the rear side 128 of the power system 54 is shown on the right. A first hose 130 is used to route fluid 104 from the front of the cooler 74 to a first terminal 132 of the output block 106 on the rear of the power source 70. The first terminal 132 is fluidicly coupled to a second terminal 134 of the output block 106. The output cable 108 is connected to the second terminal 134 and a third terminal 136. The second and third terminals are operable to couple both cooling fluid and electric current to the output cable 108. Supply fluid flows to the heating cable 56 through the second terminal 134 and returns from the heating cable 56 through the third terminal 136. The third terminal 136 is, in turn, fluidicly coupled to a fourth terminal 138. A second hose 140 is connected between the fourth terminal 138 and the temperature controller 72. A third hose 142 is connected between the temperature controller 72 and the cooling unit 74 to return the cooling fluid to the cooling unit 74, so that heat may be removed.

The ends of the first and second induction heating cables 56, 57 may be coupled to different terminals of the power source 70 to change the direction of current flow through the cables. In the illustrated embodiment, the output block 106 also may be adapted to supply electric current to air-cooled induction devices (not shown). An electrical jumper cable 144 is used to route 460 Volt, 3-phase power to the power source 70. Various electrical cables 146 are provided to couple 115 Volt power from the step-down transformer 100 to the temperature controller 72 and the cooling unit 74.

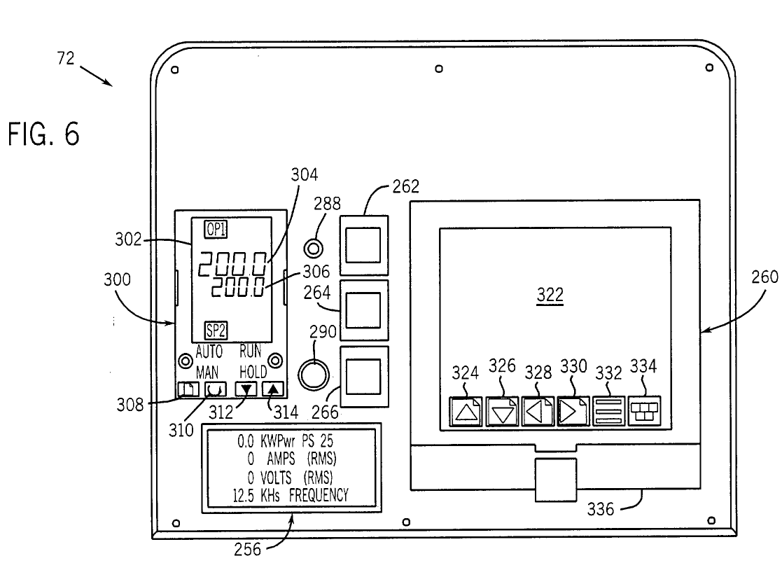

Referring generally to FIG. 6, the illustrated embodiment of the temperature controller 72 has a number of instrumentation and control features. One instrumentation feature is the parameter display 256. The parameter display 256 provides a user with system operating parameter data. For example, the illustrated parameter display 256 is operable to provide a user with the power available from the power source 70 and the power that is currently being provided by the power source 70. The parameter display 256 also is operable to provide a user with the values of the AC output current and the AC output voltage of the power source 70. The parameter display 256 also is operable to provide a user with the frequency of the AC output current to the flexible inductive heating cable 56. Additionally, the display 256 is operable to provide messages indicating, for example, a coolant flow error or power source limit error. The temperature controller 72 also has a digital display 260 operable to display temperature data recorded over time.

The temperature controller 72 also has a number of electrical switches that enable a user to control operation of the system. The switches include a run button 266, a hold button 268, and a stop button 270. The run button 266 starts the operation of the system. The hold button 268 pauses the operation of the system. Finally, the stop button 270 stops operation of the system. The temperature controller 72 also has a plurality of visual indicators to provide a user with information. One indicator is a heating light 288 to indicate when power source output contacts are closed to enable current to flow from the power source 70 to the induction heating cable 56. Another indicator is a fault light 290 to indicate to a user when a problem exists. The fault light may be lit when there is an actual fault, such as a loss of coolant flow, or when an improper power source condition exists, such as a power or current limit or fault.

In addition, the temperature controller 72 also has a number of operators and indicators that enable a user to operate the system 50. For example, the temperature controller 72 also comprises a temperature module 300 that enables a user to input programming instructions to the system. The illustrated temperature module 300 has a digital display 302 that is operable to display programming instructions that may be programmed into the system 50. In the illustrated embodiment, the digital display 302 is operable to display both the actual wound core temperature 304 and a target temperature 306 that has been programmed into the system 50. The digital display 302 may also display other temperature information, such as the segment type/function and the programmed rate of temperature change. The illustrated temperature module 300 has a page forward button 308, a scroll button 310, a down button 312, and an up button 314 that are used to program and operate the system 50. To program the temperature controller 72, the page forward button 308 is operated until a programming list is displayed.

Each heating operation for each segment of a temperature profile may be programmed into the temperature controller 72 from the programming list. The system 50 is operable to perform at least four basic types of heating operations: step, dwell, ramp rate, and ramp time. A step operation is a heating operation where the desired temperature of the wound core changes in a step increment from a current value to a new value. The system 50 will automatically begin operating to change the wound core temperature to the new value. A dwell operation is a heating operation wherein the system automatically operates to maintain the wound core at a desired temperature for a specified period of time. A ramp time operation is a heating operation wherein the system operates to change the wound core temperature linearly from a current value to a new value over a defined period of time. The ramp rate operation is a heating operation wherein the system operates to ramp the wound core temperature linearly from a current temperature to a new temperature at a defined rate of change. The specific type of heating operation may be selected from the programming list using the scroll button 310. The up button 314 and the down button 312 enable a user to input specific desired values to the temperature controller 72.

Additionally, the digital recorder 260 has a touch-screen display 322 that is present on the exterior of the temperature controller 72. The illustrated touch-screen display 322 is operable to display temperature information from one or more temperature feedback devices 59 that may be used. For example, the touch-screen display 322 is operable to visually graph the temperature of the wound core over time. The touch-screen display 322 may be operable to display system operating parameter information, as well. The touch-screen display 322 is operable to display a number of icons that are activated by touching the touch-screen display 322. The illustrated touch-screen display 322 has a page up icon 324, a page down icon 326, a left icon 328, a right icon 330, an option icon 332, and a root icon 334. The touch-screen display 322 may have additional or alternative icons. The name of the system user who performed the inductive heating operation may be added for display on the touch-screen display 322. Other information, such as a description of the wound core 52, may also be added for display. Additionally, the illustrated data recorder 260 has a disc drive 336. The disc drive 336 is operable to receive data stored in the data recorder 260 for transfer to a computer system. In addition, or alternatively, to the disc drive 336, the recorder 260 may have the capability for networking, such as a RJ45 network connection, and/or a PCMCIA card.

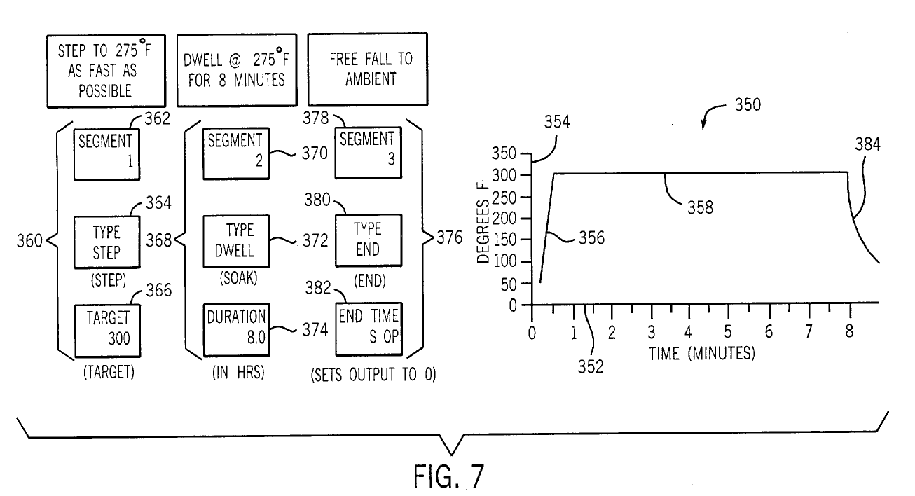

Referring generally to FIG. 7, an example of an induction heating operation that may be programmed into the temperature controller 72 to cure varnish disposed on a wound core is illustrated. In FIG. 7, the x-axis 352 represents time in minutes and the y-axis 354 represents temperature in degrees Fahrenheit. The illustrated pre-heating temperature profile 350 has a first segment 356 and a second segment 358. During the first segment 356, it is desired that the temperature of the wound core 52 rise from its present temperature to 275° F. During the second segment 358, it is desired that the wound core 52 remain at 275° F. for 8 minutes.

To program the system 50, the temperature profile 350 is broken up into segments. To produce the first segment 356 of the temperature profile 350, a first series 360 of programming instructions are provided to the temperature controller 72. The page forward button 308 is operated until the programming list is displayed. The segment function is selected from the programming list and set for a first segment, as represented by icon 362 displayed on the digital display 302. The step function is then selected from the programming list, as represented by icon 364 displayed on the digital display 302. The up button 314 and/or the down button 312 are operated to set the desired temperature for the step function to 300° F., as represented by icon 366 displayed on the digital display 302.

A second series 368 of programming instructions are provided to the temperature controller 72 to produce the second segment 358 of the temperature profile 350 in the wound core. The segment function is selected from the programming list and set for a second segment, as represented by icon 370 displayed on the digital display 302. The dwell function is then selected from the programming list, as represented by icon 372. The duration of the dwell function is then set for 8 minutes, as represented by icon 374 displayed on the digital display 302. To end the pre-heating operation, a third series 376 of programming instructions are provided to the temperature controller 72. The segment function is selected from the programming list and set for a third segment, as represented by icon 378 displayed on the digital display 302. The end heating function is then selected from the programming list, as represented by icon 380 displayed on the digital display 302. The output power of the system 50 is set to 0, as represented by icon 382 displayed on the digital display 302. The temperature of the wound core 52 will fall to ambient temperature, as represented by the third segment 384 of the temperature profile 350.

To start the heating operation, the run button 266 is operated. The power source is energized and the heat on light 288 illuminated. In addition, the power source parameters are displayed on the parameter display 256 and the temperature information from the temperature feedback device 59 is displayed on the temperature controller 72. The temperature controller 72 controls operation of the power source 70 to heat the wound core according to the programmed instructions.

Referring generally to FIG. 8, an alternative technique for inductively heating the wound core 52 is illustrated. In this embodiment, the first induction heating cable 56 is routed around the frame 55 to form the first coil 60 and the second coil 61. The first induction heating cable 56 is wound around the frame 55 in a first direction to form the first coil 60 and routed around the frame 55 in a second direction to form the second coil 61. The wound core 52 is disposed within the frame 55 so that the first coil 60 heats a portion of the wound core 52 and the second coil 61 heats another portion of the wound core 52.

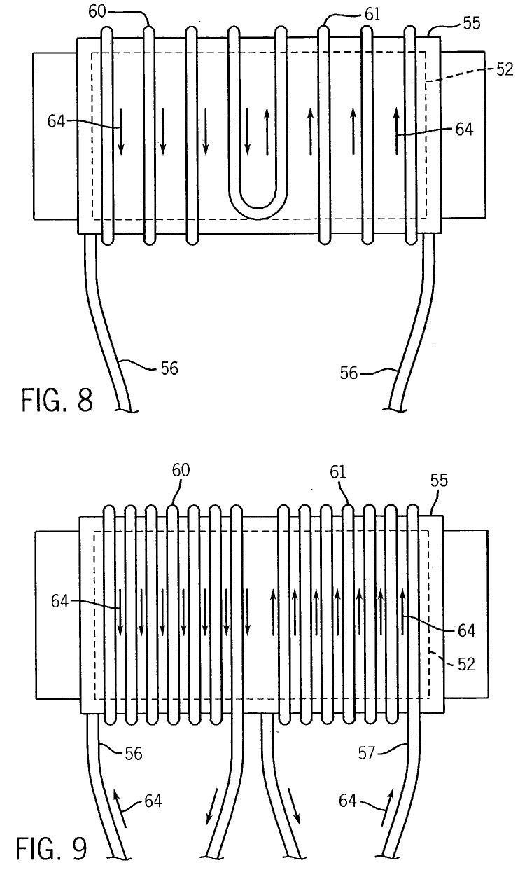

Referring generally to FIG. 9, a second alternative technique for inductively heating the wound core 52 is illustrated. In the illustrated embodiment, the first induction heating cable 56 is routed around the frame 55 to form the first coil 60 and the second induction heating cable 57 is routed around the frame 55 to form the second coil 61. In this embodiment, the first and second coils 60, 61 are wound in the same direction around the frame 55. However, the connections of the second induction heating cable 57 to the power source 70 are reversed from those of the first induction heating cable 56. Thus, the current 64 flows through the second induction heating cable 57 in the opposite direction from the current 64 flowing in the first induction heating cable 56. Consequently, even though the second coil 60 is wound in the same direction around the frame 55 as the first coil 60, the second magnetic field 67 is oriented in the opposite direction as the first magnetic field 66.

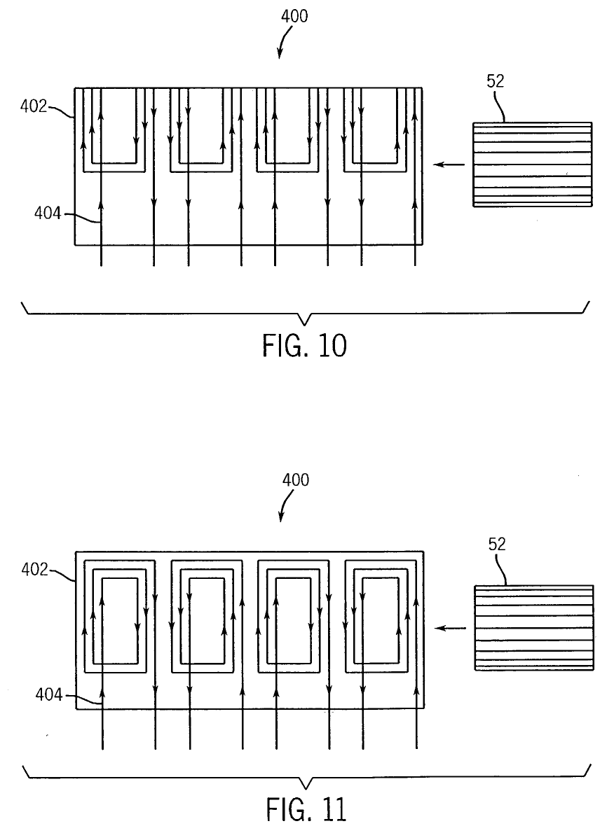

Referring generally to FIGS. 10 and 11, an alternative induction heating system 400 for curing a varnish disposed on a wound core is illustrated. In this embodiment, the induction heating system 400 comprises a clam-shell apparatus 402 adapted to extend over a wound core 52, rather than a cylindrical apparatus adapted to receive a wound core therein. In the illustrated embodiment, the clam-shell apparatus 402 has a plurality of coils 404. However, the coils 404 are not wound circumferentially around the clam-shell apparatus 404. Rather, each coils 404 is wound laterally relative to the clam-shell apparatus 404. The coils 404 are arranged and electrically coupled to the induction power source so that the magnetic fields produced by the coils 404 alternate in direction from coil-to-coil along the length of the clam-shell apparatus 404.

It will be understood that the foregoing description is of preferred exemplary embodiments of this invention, and that the invention is not limited to the specific forms shown. For example, the various induction heating operations discussed above is not intended to be an exclusive list of portable induction heating system operations. The portable induction heating system may be configured to inductively heat a wound core to perform a myriad of different heating operations. In addition, the induction heating cable may be arranged in many different physical arrangements around a wound core. Additionally, the portable induction heating system may be operated to heat a wound core according to an almost infinite number of different temperature profiles. These and other modifications may be made in the design and arrangement of the elements without departing from the scope of the invention as expressed in the appended claims.

What is claimed is:

1. An induction heating system for heating a work piece, comprising:
an induction heating assembly adapted to produce a first magnetic field and a second magnetic field to heat the work piece by induction, the first and second magnetic fields being oriented in opposite directions.

2. The system as recited in claim 1, wherein the induction heating assembly comprises a plurality of coils.

3. The system as recited in claim 2, wherein the plurality of coils comprises a first coil and a second coil, wherein the first coil is adapted to produce the first magnetic field and the second coil is adapted to produce the second magnetic field.

4. The system as recited in claim 3, wherein the first and second coils are coiled in opposite directions relative to the induction heating assembly.

5. The system as recited in claim 3, wherein the first and second induction heating coils are coiled in the same direction relative to the induction heating assembly.

6. The system as recited in claim 2, wherein at least one of the plurality of coils comprises a litz cable.

7. The system as recited in claim 1, wherein the induction heating assembly is adapted to extend over the work piece.

8. The system as recited in claim 2, wherein the plurality of coils are disposed circumferentially around the induction heating assembly.

9. The system as recited in claim 2, wherein the plurality of coils are disposed laterally along the induction heating assembly.

10. An induction heating system, comprising:
an induction heating power source; and
an inductive heating assembly, comprising:
a first induction heating coil electrically coupleable to the induction heating power source to produce a first magnetic field oriented in a first direction; and
a second induction heating coil electrically coupleable to the induction heating power source to produce a second magnetic field oriented in a second direction opposite the first direction.

11. The system as recited in claim 10, wherein the induction heating assembly is adapted to dispose a first portion of a wound core within the first magnetic field and a second portion of the wound core within the second magnetic field.

12. The system as recited in claim 10, wherein the first induction heating coil are wound in opposite directions.

13. The system as recited in claim 10, wherein the first induction heating coil and second induction heating coil are wound in the same direction.

14. The system as recited in claim 10, wherein the first and second induction heating coils are coupled separately to the induction heating power source.

15. The system as recited in claim 10, wherein the first and second induction heating coils are coupled electrically in series.

16. An induction heating system, comprising:
at least one induction heating coil, wherein a first portion of the at least one induction heating coil is coiled in a first direction and a second portion of the at least one induction heating coil is coiled in a second direction opposite the first direction.

17. The system as recited in claim 16, wherein the first portion of the at least one induction heating coil and the second portion of the at least one induction heating coil are located adjacent to each other.

18. The system as recited in claim 16, wherein the first portion of the at least one induction heating coil comprises a first induction heating cable and the second portion of the at least one induction heating coil comprises a second induction heating cable electrically coupled to the first induction heating cable.

19. The system as recited in claim 16, comprising a coil support adapted to receive a wound core of one of a motor and a generator.

20. An induction heating system, comprising:
an induction heating power source; and
at least one induction heating coil electrically coupleable to the induction power source, wherein a first portion of the at least one induction heating coil is coiled in a first direction and a second portion of the at least one induction heating coil is coiled in a second direction opposite the first direction.

21. The system as recited in claim 20, comprising a coil support adapted to support the at least one induction heating coil.

22. The system as recited in claim 21, wherein the support structure is adapted to receive a wound core of one of a motor and generator.

23. The system as recited in claim 22, comprising a temperature controller electrically coupled to the induction heating power source, where the temperature controller is adapted to control the operation of the induction heating power source to automatically heat the wound core to cure a coating disposed on the wound core.

24. The system as recited in claim 19, comprising a fluid cooling system, wherein the at least one induction heating c is adapted for fluid cooling and is fluidly coupled to the fluid cooling system.

25. An induction heating system, comprising:
an induction heating power source;
a first induction heating coil wound in a first direction, the first induction heating coil being electrically coupleable to the induction heating power source to produce a first electric current; and
a second induction heating coil wound in the first direction, the second induction heating coil being electrically coupleable to the induction heating power source to produce a second electric current,
wherein the first electric current flows through the first coil in a first direction and the second electric current flows through the second coil in a second direction opposite the first direction.

26. The system as recited in claim 25, wherein the first coil produces a first magnetic field and the second coil produces a second magnetic field, the first magnetic field opposing the second magnetic field.

27. The system as recited in claim 25, wherein the support structure is adapted to receive a core of one of a motor and a generator for induction heating.

28. The system as recited in claim 25, wherein each induction heating coil comprises a litz cable.

29. A method of inductively heating a wound core, comprising:
disposing a wound core having a coating within a coil assembly;
coupling the coil assembly to an induction heating power source; and
applying power from the induction heating power source to the coil assembly to inductively heat the wound core.

30. The method as recited in claim 29, wherein applying power comprises applying power from the induction heating power source to the coil assembly to produce a first magnetic field oriented in a first direction through the wound core and to produce a second magnetic field oriented in a second direction through the wound core.

31. The method as recited in claim 29, wherein coupling comprises electrically coupling the coil assembly to the induction heating power source to produce a first magnetic field and a second magnetic field, the first and second magnetic fields being oriented in opposite directions.

32. The method as recited in claim 29, wherein coupling comprises electrically coupling a first coil and a second coil of the coil assembly to the induction heating power source.

33. The method as recited in claim 29, wherein coupling comprises coupling the first coil to the induction power heating system to produce a first current through the first coil and coupling the second coil to the induction power heating system to produce a second current through the second coil, the first and second currents flowing around the wound core in opposite directions.

34. The method as recited in claim 29, wherein applying power from the induction heating power source to the coil assembly comprises providing a temperature controller to control power from the induction heating power source to obtain a desired temperature in the wound core.

35. The method as recited in claim 29, wherein applying power comprises establishing a desired output from the induction heating power source and inductively heating the wound core for a specified time period.
